(19) United States
(12) Patent Application Publication
(10) Pub. No.: US 2010/0223604 A1
(43) Pub. Date: Sep. 2, 2010

(54) MODULE SYSTEM FOR POLYMORPHIC PI-CALCULUS

(76) Inventors: George Kuan, Chicago, IL (US); Dachuan Yu, Foster City, CA (US); Dinakar Dhurjati, Sunnyvale, CA (US); Ajay Chander, San Francisco, CA (US); Hiroshi Inamura, Kanagawa (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/683,930

(22) Filed: Jan. 7, 2010

Related U.S. Application Data
(60) Provisional application No. 61/156,329, filed on Feb. 27, 2009.

(51) Int. Cl. G06F 9/45

(52) U.S. Cl. 717/141

(57) ABSTRACT

A method and apparatus is disclosed herein for using a module system for polymorphic π-calculus. In one embodiment, the method comprises receiving a formal specification of a software program; and performing automatic analysis on the formal specification using a module system fitted with processes of the polymorphic π-calculus processes.

### PRIORITY

The present patent application claims priority to and incorporates by reference the corresponding provisional patent application Ser. No. 61/156,329, titled “A Module System for the Polymorphic π-Calculus,” filed on Feb. 27, 2009.

### FIELD OF THE INVENTION

The present invention relates to the field of type-safe computer programs and specification languages; more particularly, the present invention relates to performing typechecking based on a principled module system for a concurrent language.

### BACKGROUND OF THE INVENTION

As programmers construct and specify increasingly complex concurrent systems, modularity becomes more important. One of the original motivations for an explicit program module system was to provide a simple means for mutual exclusion in the monitor construct. A module system enables programmers and program specification writers to reuse systems, to independently develop components of a larger system, and to detect errors at the coarse-grain systems level. A module system also provides programmers and program specifiers with more control over how systems can be composed into larger systems.

In the λ-calculus, a program can go wrong by only applying a non-function to an argument. In contrast, π-calculus programs can go wrong in various ways. For example, runtime errors as a disagreement on arity between matching input and output prefixes could occur. Other runtime errors include sending the names with the wrong type over a channel and misusing channels that are designated send- or receive-only.

Conventional module systems were designed with only sequential core languages in mind where λ-abstractions and function applications are the primary forms. Modules consist of sequences of value declarations that bind λ-expressions to variables (i.e., val f=λx:x binds the variable f to the λ-abstraction λx:x). The bound variable can be referenced in subsequent value declarations. The semantics requires early declarations to be executed before subsequent declarations. Implementations typically follow a completely sequential semantics where declarations are executed in sequence. This semantics is incompatible with the π-calculus because there is no notion of a value in π-calculus. Moreover, the fact that declarations must be executed in order violates the spirit of π-calculus which assumes a concurrent semantics for processes.

The ML module system has always been designed around sequential core languages. The module system itself has several constructs that assume sequential execution. In particular, it is assumed that functor applications are executed in sequence as well as initialization code inside bindings. Declarations are written inside modules in sequence. Because types do not truly depend on values, the order between types and values is irrelevant. Types may appear to depend on submodules, but due to the phase distinction property (i.e., all programs can be decomposed into a dynamic and static part which does not depend on the former), this dependence does not lead to any noteworthy complications.

The ML module system has several noteworthy distinctions that set it apart from other forms of modularity. First of all, the ML module system is a typed module system. Interfaces in the form of module and functor signatures include type components both type definitions and abstract types. Because functors map modules to other modules based on the signature, ML modules in essence parameterize on types.

There are a number of instances of work that is related to π-calculus. For example, a locally type inferred PICT language uses various syntactic sugar to make programming in π-calculus more palpable. In particular, a def process abstraction syntax is translated into the requisite v name restrictions, receives, and process body. In another example, Blue Calculus provides a more reasonable language for programming the π-calculus by eliminating the continuation-passing style. Polymorphic type systems and type inference have been developed for the Blue Calculus. Using these polymorphic type systems and type inference, π-calculus systems may be programmed in a direct-style.

Another example is System F which provides an impredicative polymorphic π-calculus and a type inference algorithm for that calculus. Both type-preserving encoding of System F in an impredicative polymorphic π-calculus and an embedding of System F in a second-order polymorphic π-calculus have been developed.

In MOCHA, reactive modules target model checking for concurrent systems specifically are provided. The system uses assume-guarantee rules, abstraction operators, and hierarchical composition. Reactive modules are at the core stateful yet not based on message passing. They also do not support higher-order specifications and reasoning. Although MOCHA has a simple type system, there is no support for type abstraction.

### SUMMARY OF THE INVENTION

A method and apparatus is disclosed herein for using a module system for the polymorphic π-calculus. In one embodiment, the method comprises receiving a formal specification of a software program; and performing automatic analysis on the formal specification using a module system fitted with processes of the polymorphic π-calculus processes.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 illustrates typed 7E-calculus.

FIG. 2 illustrates a module system.

FIG. 3 is a flow diagram of one embodiment of a process for performing typechecking based on a principled module system for a concurrent language.

FIG. 4 illustrates an architecture of the module system

FIG. 5 illustrates motivating example for internal-external names.

FIG. 6 illustrates Leroy's type system for modular modules with some notational changes.

FIG. 7 illustrates modular modules subtyping.

FIG. 8 illustrates type equivalence (congruence, reflexivity, symmetry, transitivity omitted).

FIG. 9 illustrates Dreyer-Crary-Harper 03 subtyping relation.

FIG. 10 illustrates type system adapted to π-calculus.

FIG. 11 illustrates evaluation context reduction semantics.

FIG. 12 illustrates reduction semantics for subtyping.

FIG. 13 is a block diagram of one embodiment of a computer system.

### DETAILED DESCRIPTION OF THE PRESENT INVENTION

A principled module system for use in a concurrent language based on the π-calculus is described. In one embodiment, the module system is modeled after ML-like module systems that collects both type and value components into modules that can be parameterized. The combination of π-calculus and a module system and a type checking semantics for that language are described.

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

### Overview

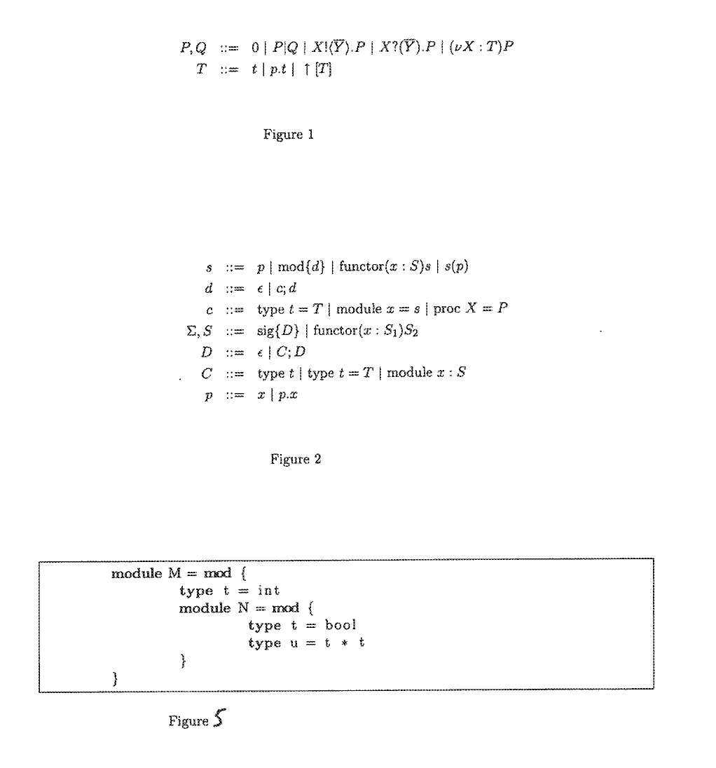

An embodiment of the present invention provides a principled module system, formally defined in terms of a semantics for concurrent programming languages and concurrent specification languages. FIG. 1 describes one embodiment of the module system using a core language of a standard typed n-calculus variant. Instead of the expressions found in sequential languages, the fundamental construct in the n-calculus is the process. 0 is the inert process. P|Q represents the parallel composition of two concurrently running processes P and Q. X!( Y̅). P sends a sequence of channel names Y̅ over a channel named X and proceeds with process P. X?( Y̅). P receives over a channel named X a sequence bound of the channel names Y̅ and then proceeds with process P. (νX:T)P creates a new channel X that carries only data of type T in the scope of P. A channel with type ↑[T] only carries messages of type T. Channel types T also include channel type variables t and paths to channel type variables p.t.

### A Module System Syntax

FIG. 2 gives the syntax of the module system fitted with n-calculus processes rather than value declarations. Let ε denote the empty sequence. Modules can be referenced as paths p, a base module mod {d} consisting of a possibly empty sequence of components, a functor, and a functor application. Module components c consist of type definitions (type t=T), nested modules (module x=s), and process components (proc X=P). A process component proc X=P binds a channel name X over which the result of process P should be sent. Alternatively, one can consider proc X=P as a module system-level component that is equivalent to (νX)P.

A functor functor(x:S)s parameterizes over a module matching a signature S according to the subtyping (subsignature) relation in FIG. 8 described below. The module is said to match the signature (S) if its signature (S′) is a subsignature of S (S′<:S). The module system is higher-order because signatures include functor signatures (functor(x:S₁)S₂); that is, functor arguments may include functor components.

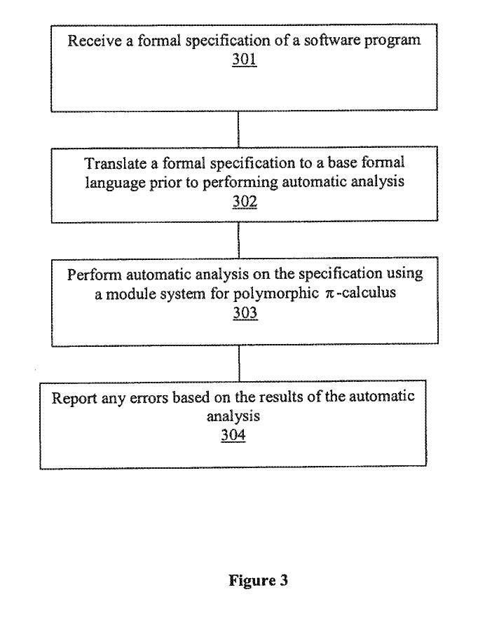

The model system described herein can be used for type-checking. FIG. 3 is a flow diagram of one embodiment of a process for performing typechecking based on a principled module system for a concurrent language. The process is performed by processing logic which may comprise hardware (e.g., circuitry, dedicated logic, etc.), software (such as is run on a general purpose computer system or a dedicated machine), or a combination of both.

Referring to FIG. 3, the process begins by processing logic receiving a formal specification of a software program (processing block 301). In one embodiment, the system parses the specification (which may be the program itself), type-checks, and checks module-level subtyping.

Next, the process may optionally include translating a formal specification to a base formal language prior to performing automatic analysis (processing block 302). Performing such a translation is well-known in the art. In one embodiment, the formal specification is a user level specification and the translation occurs into an intermediate specification language. The following fragment defines a functor “a” that expects a module with two constrained (abstract) type components t and u. A module containing types t and u, simple channel types of the form ̂ ( ), i.e., a channel that expects a unit type. This is an example of the intermediate specification language. ((fct a (sig{atype t, atype u}) mod{module c is mod {nil}, module d is mod {nil}}) (mod{type t=̂ ( ), type u=̂( )})). The user level language can be SDL or alternative specification languages, possibly fitted with a module system at that level.

After any translation, processing logic performs automatic analysis on the specification using a module system fitted with polymorphic π-calculus (processing block 303). In one embodiment, the module system supports concurrent systems and uses asynchronous message passing. In one embodiment, performing automatic analysis comprises locating errors in the specification. In one embodiment, locating errors in the specification is based on type inferences. In one embodiment, performing automatic analysis includes reconstructing missing type annotations and identifying conflicts between type inferences.

After performing an automatic analysis, processing logic reports any errors based on the results of the automatic analysis (processing block 304). In one embodiment, the error reports where the modules do not match. The reporting system may be in the form of a printed output or report. Alternatively, the reporting may be electronic in the form of an output to a display or stored in a computer readable file. The reporting may be through a user-interface and displayed and/or manipulatable for the user. In one embodiment, the process also includes processing logic that performs error repair on the specification (or program) and these fixes may occur automatically.

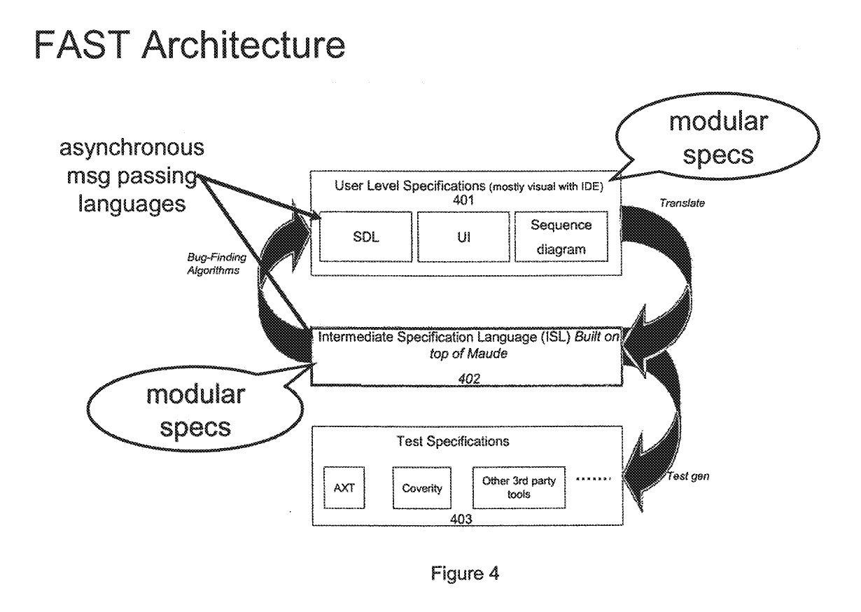

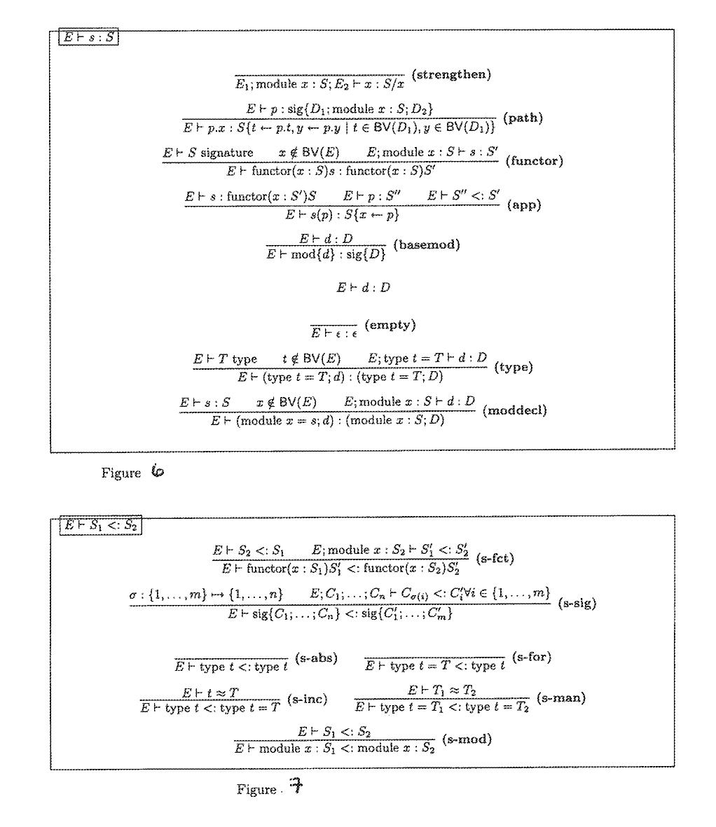

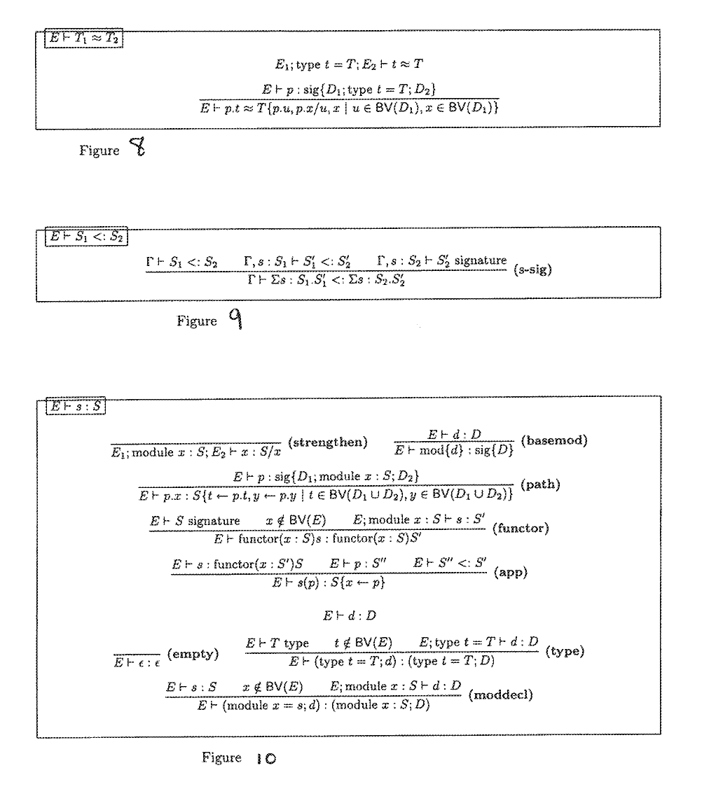

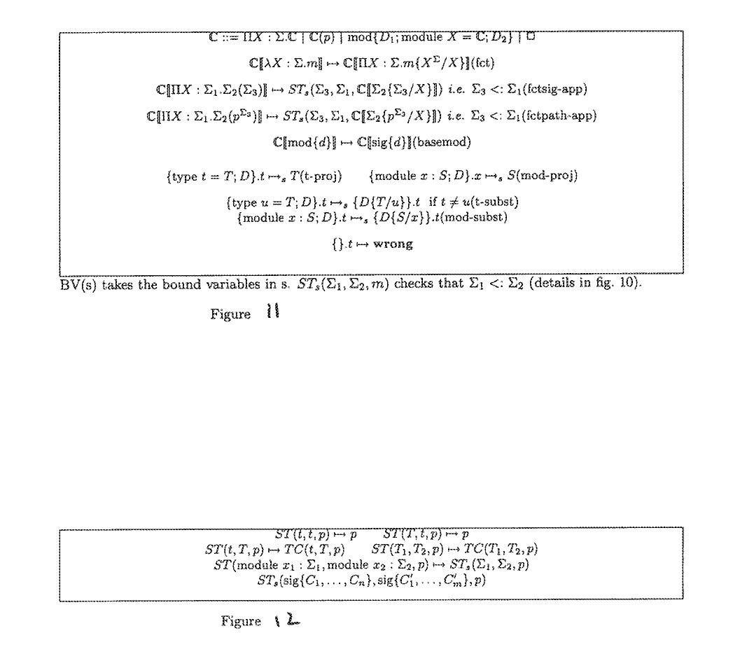

FIG. 4 illustrates an architecture of the module system. Referring to FIG. 4, the module system works on a user level specification 401 which is translated into an intermediate specification language 402. The module system also works on the intermediate level specification 402. Bug-locating algorithms identify problems and the results of that analysis are fed back to make corrections on the user level specifications 401. In both instances, the user level specification 401 and the intermediate specification language 402 use asynchronous message passing languages to interact with each other. The results of the analysis on the intermediate specification language 402 are the test specifications that are provided to a test generator.

The module system is similar to Leroy's modular module system described in “A Modular Module System,” by Xavier Leroy, J. Funct. Program, 10(3):269-303, 2000, with deviations as detailed in FIGS. 6-8, is incorporated herein, and is well-known in the art. First, the internal-external name distinction that has become convention has been omitted. The motivation for internal-external names was primarily to provide a more flexible way to scope components in enclosing modules. The real problem internal-external names solve is the lack of a principled means for referencing paths in reverse. In particular, in FIG. 3 there is no way for M.N.u to refer to M.t because of the local t shadowing M.t. This distinction is actually irrelevant when it comes to type checking, thus is ignored for this discussion.

Second, Leroy's strengthening operation which supports type sharing constraints is eliminated because the calculus described herein does not support type sharing. Details are given in FIG. 6. A key rule to note is that the (app) rule must check that the argument (actual) signature S″ is a subtype of the formal parameter (specification) signature S′, i.e. the subsumption rule is integrated into the (app) rule. The subsumption rule says one can use components of more precise types in place in place of where one expects less precise ones. For example, a square is a more specific than a shape, so a square can be used wherever one expects a shape. This rule gives the module system most of its flexibility and provides potential for code reuse. In one embodiment, this rule permits functors to work with modules that are not an exact match. Modules may contain more components than are necessary, i.e., extra components. The components may be more polymorphic than required by the functor. For example, the constraint may require a component with type int->int, but a module containing a component with type X->X would satisfy this constraint.

FIGS. 11 and 12 illustrate novel roles. Rule (fct) decomposes functors. Rules (fctsig-app) and (fctpath-app) check whether the functor parameter constraint is respected by delegating to the FIG. 12 rules for the general and path case respectively. Rule (basemod) sets up the program/specification fragment for checking. Rules (t-proj) and (mod-proj) project out type and submodule specifications from completely checked modules or from module signatures respectively. Rules (t-subst) and (mod-subst) propagate the result of checking (i.e., types and module signature) to the rest of the declarations. The last rule in FIG. 11 catches erroneous type projections.

With polymorphism, the subtyping relation becomes significantly richer. The specification signature may refine polymorphic types in the actual signature by instantiating some of the polymorphic types to ground types.
sig {val length:′a list->int}

<:sig {val length:bool list->int}

The subtyping rules are provided in FIG. 7. Following Leroy, σ in (s-sig) is an injection that is uniquely determined by the names of the components of the signatures. The (s-inc) is designed to take into account other type manifest specifications that may make the type equality true. In particular, Leroy offers the example sig{type t; type u=t}<: sig{type u; type t=u}. Both (s-inc) and (s-man) appeal to the core language type checking judgment E├T₁≈T₂.

Type equivalence is standard and FIG. 8 shows the type system adapted to π-calculus.

### Signature Subtyping

FIG. 9 illustrates the Dreyer-Crary-Harper's signature subtyping relation, (Silvano Dal Zilio, Le calcul bleu: types et objets, PhD thesis, Universite de Nice—Sophia-Antipolis, 1999.), which looks somewhat different. Because modules are built from atomic modules in the DCH module calculus, signatures are also constructed piecemeal. The (s-sig) rule in the DCH calculus does not explicitly model width subtyping and reordering of fields because the claim is that these features are definable in the module language.

Leroy's module system assumes a sequential base language in a number of points. Rule (path) assumes module bindings to be sequentially scoped. This design is also due to the lack of recursion in the module system. Without adding recursion at the module level outright, the scope of the module binding x can be expanded to include D₂. Leroy's type system is refined to account for these adjustments in the type system presented in FIG. 10.

### Typechecking

Typically typechecking algorithms and especially module systems are given in a type-theoretic declarative form and some algorithmic form that is more amenable to implementation. An evaluation context reduction semantics for typechecking effectively bridges the gap between these two kinds of semantics. In the spirit of Kuan-MacQueen-Findler (Kuan, et al., “A Rewriting Semantics for Type Inference,” in Rocco De Nicola, editor, Programming Languages and Systems, 16th European Symposium on Programming, ESOP 2007, volume 4421, pages 426-440, March 2007), a substitution-based evaluation context reduction semantics is included for the module type system. This reduction semantics has a direct correspondence to an Ellison-Rosu-style rewriting logic semantics (Ellison, et al., “A Rewriting Logic Approach to Typeinference,” in 19th International Workshop on Algebraic Development Techniques, 2008) and the bottom-up type checking algorithm by way of refunctionalization (Danvy, “Refunctionalization at Work,” in Mathematics of Program Construction, 2006). Because of this correspondence, the fact that the semantics is substitution-based is non-essential, but substitution-based semantics may be clearer and perhaps amenable to Maude's ACI optimizations.

To review, reduction semantics rules decompose programs into a context (whose form must be defined syntactically) and a focus (redex). The focus term sits somewhere inside the context. Rules transform context-focus pairs into context-focus pairs where the resultant context may be modified or even empty. The rules always take the form [symbol] [symbol] where [symbol] and [symbol] are possibly empty contexts and s₁ is the focus. For brevity, functors functor(X:S)s and functor signatures functor(X:S₁)S₂ will be abbreviated λX:S.s and πX: Σ₁:Σ₂ as is well-known in the in module system art.

FIG. 11 illustrates the evaluation context reduction semantics. The evaluation context C is defined such that the bodies of functors (πX:Σ. [symbol] ), the left-side of functor applications ( [symbol] (p)), and the individual components of base modules (mod {D₁; module X= [symbol] ;D₂}) are all typechecked. As standard in reduction semantics notation, □ (read “hole”) matches everything and stands in for the focus of a reduction in the context decomposition.

The (fct) rule takes functors into functor signatures by turning the λ to π and replacing all occurrences of the bound module variable X with an explicit substitution, its signature p^{Σ}. The context decomposition causes the semantics to typecheck the body of the functor. An explicit substitution is used rather than eliminate the path p because the original path is needed in order to substitute in the signature of the actual argument upon application. For example, let Y.m=mod{type t=int}. When typechecking (λY:sig{type t}.m₁)Y.m, the typechecker notes that in the signature resulting from this functor application, Y=Y.m:sig{type t=int} and not the less descriptive signature sig{type t}. To typecheck functor applications, two forms are needed, fctsig-app and fctpath-app. This departs from the typechecking reduction semantics for the simply-typed λ calculus in Kuan-MacQueen-Findler which only has a single application rule similar to fctsig-app. The actual signature of p, Σ₃ is needed in order to check for the signature subtyping relationship, which is done by the STₛ relation. (basemod) prepares for typechecking base modules by turning mod{ } into sig{ }. A second reduction relation [symbol] simplifies projections of types and nested modules from modules. It mostly follows the substitution semantics given by Leroy.

There are a few issues in devising a reduction semantics for type checking the module system for the π-calculus.
1. Because a declaration may depend on other parallel declarations, a determination is needed as to when those should be substituted. To properly eliminate any dependencies by substitution, two passes over the declarations are needed, once to do substitution and the second time to find the desired element to project out. A simple one-pass scheme suffices if the original Leroy semantics are to be maintained.
2. Distinguishing between a genuine empty module mod { } and an error state (where its rewritten to wrong) would be interesting. But is this necessary because a projection of an unbound label in each case should result in an error—unbound label.
3. Because the functor rule does not substitute away the dependent variable, then such variables may linger in the functor body.
   πY:E.(λX:sig{type t}.mod{ }(Y.m))
No substitution is made at the functor rule because then there would be no simple way to substitute the actual functor application argument signature later. The correct way to handle these cases is to permit substituting paths for the bound dependent variable when applying II-types to paths. To check that the subtyping relation works, the functor rule can substitute pathxsignature pairs (explicit substitutions) so that the signature is readily available for subtyping checks.

A major ingredient of module system type checking is the subtyping relation as shown in FIG. 12. Typically, this subtyping relation is structural. As shown in (s-sig), signatures should type check even if their components are reordered as long the ordering is still a dependency ordering.

Kuan-MacQueen-Findler provides a reduction semantics for solving type equality constraints by unification. Using that technique as an intuition, a reduction semantics for solving subtyping constraints can be developed.

### Type Error Reporting

Type error reporting is an important part of the type checking process. It is not sufficient to report the presence of a type error. In one embodiment, the type checking semantics report where the type error occurs and why. In an abstract machine semantics for type checking, an exception handler discipline can be based to encode the context of an error (consists of the variables or expressions whose types are being compared). In one embodiment, a new register H is added in the abstract machine for exception handlers.

Whenever an (applicative) syntactic form is passed through that requires a unification (in λ-calculus languages, this would be an application, in π-calculus, an output prefix), a type error context is pushed onto register H and a try frame onto the K stack before the applicative construct frame is pushed. When type checking fails due to a unification error, the K type checking continuation stack is popped until we reach the try frame is needed. At this point, the register H is popped and the substituted form of that top-most type error handler is used for the new control.

In one embodiment, the type errors are reported in polyadic output prefixes by expanding the polyadic output prefix into the corresponding monadic output prefixes.

### K Implementation

The declarative type systems presented above leave out several details that are apparent in the implementation to avoid obscuring the invention. For example, in particular, in a polyadic calculus receives may bind a single name multiple times. The canonical example is

(new a(̂(̂( ), ̂(̂( ))))(a?(c,c)NoOp))

The initial binding of c has type ̂( ) whereas the rebinding has type ̂(̂( )). In one embodiment, the rebinding of c is construed as shadowing the initial binding. This semantics imposes an ordering in the communication, i.e. the names are given in the order of transmission. With the shadowing semantics, the initial binding of c is understood to be lost both in the dynamic semantics and in the type semantics. The monadic encoding of the polyadic π-calculus seems to suggest the shadowing semantics.

The type inference algorithm differs from some prior art algorithms. Specifically, the algorithm only detects errors at sends where an actual constraint that the types of the carrier channel and the payload are consistent. This imposes an arbitrary order during inference.

### An Example of a Computer System

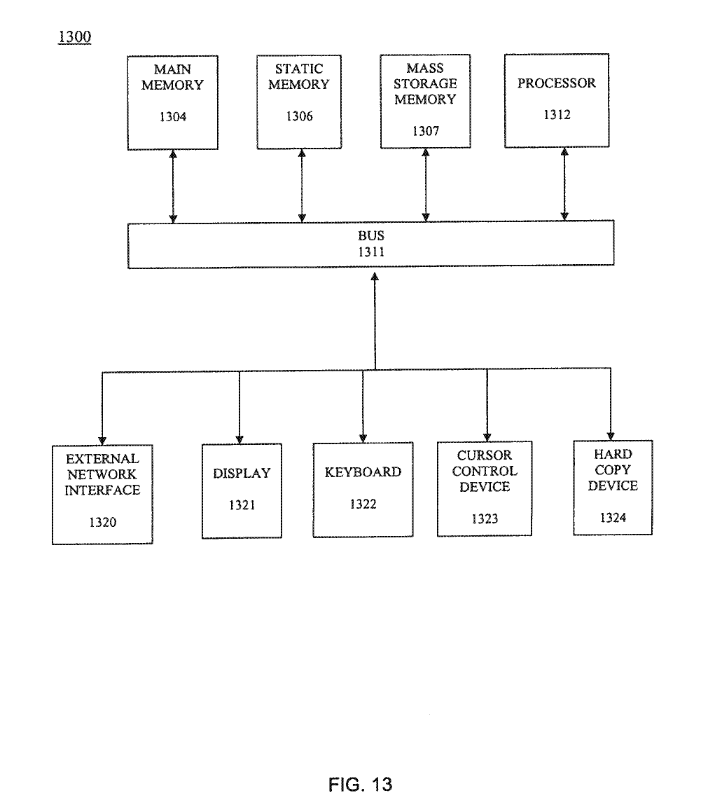

FIG. 13 is a block diagram of an exemplary computer system that may perform one or more of the operations described herein. Referring to FIG. 13, computer system 1300 may comprise an exemplary client or server computer system. Computer system 1300 comprises a communication mechanism or bus 1311 for communicating information, and a processor 1312 coupled with bus 1311 for processing information. Processor 1312 includes a microprocessor, but is not limited to a microprocessor, such as, for example, Pentium™, PowerPC™, Alpha™, etc.

System 1300 further comprises a random access memory (RAM), or other dynamic storage device 1304 (referred to as main memory) coupled to bus 1311 for storing information and instructions to be executed by processor 1312. Main memory 1304 also may be used for storing temporary variables or other intermediate information during execution of instructions by processor 1312.

Computer system 1300 also comprises a read only memory (ROM) and/or other static storage device 1306 coupled to bus 1311 for storing static information and instructions for processor 1312, and a data storage device 1307, such as a magnetic disk or optical disk and its corresponding disk drive. Data storage device 1307 is coupled to bus 1311 for storing information and instructions.

Computer system 1300 may further be coupled to a display device 1321, such as a cathode ray tube (CRT) or liquid crystal display (LCD), coupled to bus 1311 for displaying information to a computer user. An alphanumeric input device 1322, including alphanumeric and other keys, may also be coupled to bus 1311 for communicating information and command selections to processor 1312. An additional user input device is cursor control 1323, such as a mouse, trackball, trackpad, stylus, or cursor direction keys, coupled to bus 1311 for communicating direction information and command selections to processor 1312, and for controlling cursor movement on display 1321.

Another device that may be coupled to bus 1311 is hard copy device 1324, which may be used for marking information on a medium such as paper, film, or similar types of media. Another device that may be coupled to bus 1311 is a wired/wireless communication capability 1325 to communication to a phone or handheld palm device.

Note that any or all of the components of system 1300 and associated hardware may be used in the present invention. However, it can be appreciated that other configurations of the computer system may include some or all of the devices.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. A method comprising:
receiving a formal specification of a software program; and
performing automatic analysis on the formal specification using a module system fitted with polymorphic π-calculus processes.

2. The method defined in claim 1 further comprising translating the formal specification to a base formal language prior to performing the automatic analysis.

3. The method defined in claim 1 wherein the specification is a user level specification, and further comprising translating the user level specification into an intermediate specification language, and further wherein automatic analysis is performed on the specification in the intermediate specification language.

4. The method defined in claim 1 further comprising reporting an error based on results of automatic analysis.

5. The method defined in claim 1 wherein the module system supports concurrent systems that support asynchronous message passing.

6. The method defined in claim 1 wherein performing automatic analysis comprises locating errors in the specification.

7. The method defined in claim 6 wherein locating errors in the specification is based on type inferences.

8. The method defined in claim 7 further comprising reconstructing missing type annotations and identifying conflicts between type inferences.

9. An article of manufacture having one or more computer readable storage media storing instructions thereon which, when executed by system, cause the system to perform a method comprising:
receiving a formal specification of a software program; and
performing automatic analysis on the formal specification using a module system fitted polymorphic π-calculus processes.

10. The article of manufacture defined in claim 9 wherein the method further comprises translating the formal specification to a base formal language prior to performing the automatic analysis.

11. The article of manufacture defined in claim 9 wherein the specification is a user level specification, and wherein the method further comprises translating the user level specification into an intermediate specification language, and further wherein automatic analysis is performed on the specification in the intermediate specification language.

12. The article of manufacture defined in claim 9 wherein the method further comprises reporting an error based on results of automatic analysis.

13. The article of manufacture defined in claim 9 wherein the module system supports concurrent systems that support asynchronous message passing.

14. The article of manufacture defined in claim 9 wherein performing automatic analysis comprises locating errors in the specification.

15. The article of manufacture defined in claim 14 wherein locating errors in the specification is based on type inferences.

16. The article of manufacture defined in claim 15 wherein the method further comprises reconstructing missing type annotations and identifying conflicts between type inferences.

17. A system comprising:
one or more memories to store executable instructions; and
a processor coupled to the memory to execute the instructions to perform a method comprising:
receiving a formal specification of a software program; and
performing automatic analysis on the formal specification using a module system fitted with polymorphic π-calculus processes.

18. The system defined in claim 17 wherein the processor executes instructions to run the module system to support concurrent systems that support asynchronous message passing.

19. The system defined in claim 17 wherein performing automatic analysis comprises locating errors in the specification based on type inferences, including reconstructing missing type annotations and identifying conflicts between type inferences.

20. The system defined in claim 17 further comprising a display to display one or more errors identified through the automatic analysis.
